(19) United States
(12) Patent Application Publication
(10) Pub. No.: US 2010/0299876 A1
(43) Pub. Date: Dec. 2, 2010

(54) HINGE

(75) Inventor: SHENG KANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/548,067

(22) Filed: Aug. 26, 2009

(30) Foreign Application Priority Data
Jun. 2, 2009 (CN) 200910302849.3

(51) Int. Cl. E05D 3/10; E05D 11/10

(52) U.S. Cl. 16/319; 16/367

(57) ABSTRACT

A hinge includes a first shaft, a second shaft, a first bracket, and a second bracket. The first shaft is perpendicularly mounted to the second shaft. The second shaft includes an end face, which defines a recess and two positioning holes. The recess defines two barrier sides. The first bracket is pivotally mounted to the first shaft. The second bracket is pivotally mounted to the second shaft. The second bracket includes a guiding piece which slides in the recess when the second bracket rotates about the second shaft. The second bracket is rotatable about the second shaft between a first position and a second position. In the first position, the guiding piece abuts one barrier side, and the protrusion is located in one positioning hole. In the second position, the guiding piece abuts the other barrier side, and the protrusion is located in the other positioning hole.

### BACKGROUND

1. Technical Field

The present disclosure relates to device constructions, and particularly, to a hinge.

2. Description of Related Art

Collapsible devices, such as a notebook computer or clamshell mobile phone, generally include two parts pivotally connected via a hinge. A conventional hinge includes a bracket mounted to one part and a shaft with one end mounted to the other. The bracket includes a barrel rotatably receiving of the shaft.

However, the bracket or the shaft of the hinge can only rotate with respect to the other in one dimension. The flexibility of the collapsible device is usually limited by the hinge which can only rotate in one dimension.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of the hinge;

FIG. 2 is an isometric view of a second bracket of the hinge of FIG. 1;

FIG. 3 is an assembly view of the hinge of FIG. 1; and

FIG. 4 is another assembly view of the hinge of FIG. 1.

### DETAILED DESCRIPTION

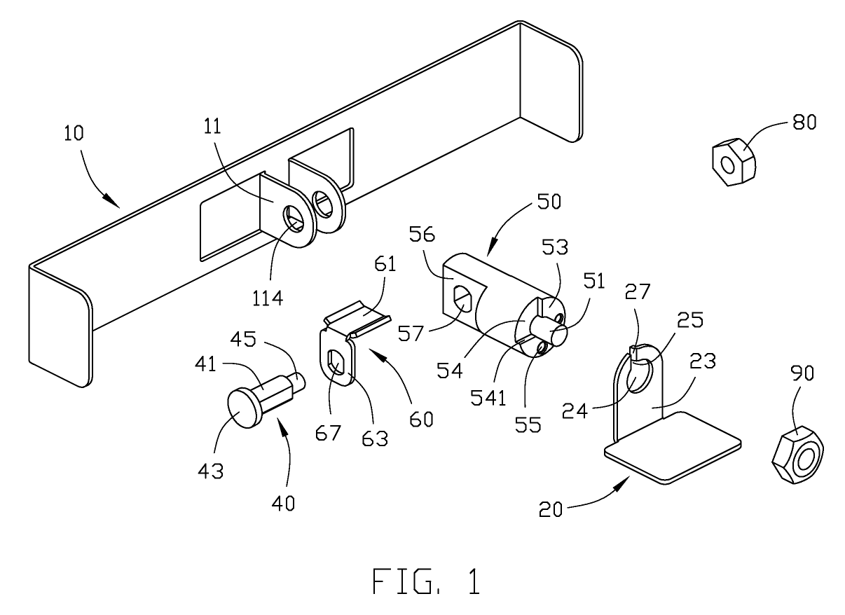

Referring to FIG. 1, a hinge in accordance with a preferred embodiment includes a first bracket 10, a second bracket 20, a first shaft 40, a second shaft 50, and a restricting member 60.

The first bracket 10 is mountable on one part of an electronic device, such as a screen of a laptop computer. The first bracket 10 includes two flanges 11, each of which defines a first pivot hole 114 therein.

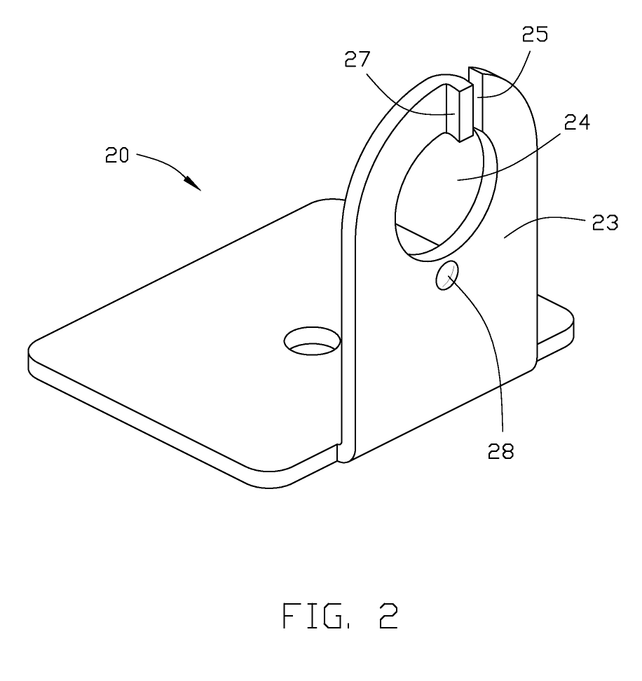

Referring to FIGS. 1 and 2, the second bracket 20 is capable of being mounted on another part of the electronic device, such as a base unit of laptop computer. The second bracket 20 includes a connection piece 23. The connection piece 23 defines a second pivot hole 24, and a cutout 25. The cutout 25 communicates the second pivot hole 24 with an outer surface of the connection piece 23. A guiding piece 27 is formed on one side of cutout 25. A resilient protrusion 28 protrudes from the connection piece 23. The guiding piece 27 and the resilient protrusion 28 extend in a same direction on the connection piece 23.

The first shaft 40 can be rotatably mounted in the first pivot holes 114 of the first bracket 10. The first shaft 40 includes a first shaft portion 41, a head 43 formed on one end of the first shaft portion 41, and a fixing portion 45 formed on the other end of the first shaft portion 41. The first shaft portion 41 has a noncircular, such as double-D shaped, cross section. A screw threading is formed on the fixing portion 45.

A front portion of the second shaft 50 has an end face 53. A second shaft portion 51 is formed on the end face 53. A screw threading is formed on the second shaft portion 51. A sector recess 54 is defined in the end face 53. Each side of the recess 54 forms a barrier side 541. Two positioning holes 55 are defined in the end face 53 providing a place for the protrusion 28 of the second bracket 20 to be inserted. A rear portion of the second shaft 50 defines a pair of parallel planes 56 on opposite sides of the second shaft 50. A mounting hole 57 is defined in the second shaft 50 between the pair of parallel planes 56. The mounting hole 57 is double-D shaped to non-rotatably fit on the first shaft portion 41. An axial direction of the mounting hole 57 and an axial direction of the first shaft portion 41 is the same, and perpendicular with an axial direction of the second shaft portion 51.

The restricting member 60 includes a restricting piece 61 and a fixed piece 63 perpendicular with the restricting piece 61. The fixed piece 63 defines a fixed hole 67that has a shape corresponding to the first shaft portion 41.

Referring to FIGS. 1 to 3, in assembly of the hinge, the rear portion of the second shaft 50 is located between the two flanges 11 of the first bracket 10 with the planes 56 facing to the flanges 11. The mounting hole 57 is in alignment with the first pivot holes 114. The restricting piece 61 is located on the flanges 11, and the fixed hole 67 of the restricting member 60 is in alignment with the first pivot holes 114. The first shaft portion 41 is inserted in the fixed hole 67 of the restricting member 60, the first pivot holes 114, and the mounting hole 57. At this position, the head 43 and the fixing portion 45 of the first shaft 40 are located on opposite sides of the second shaft 50. A fastener 80 is screwed on the fixing portion 45 to mount the first shaft 40 on the second shaft 50. Therefore, the shaft 40, 50, and the restricting member 60 are secured together. At this position, the first shaft 40 is perpendicular with the second shaft 50. The first shaft portion 41 of the first shaft 40 is rotatable in the first pivot holes 14 of the first bracket 10, and when the first shaft 40 rotates, the second shaft 50 and restricting member 60 rotates together with the shaft 40 due to the non-rotatably fitting. Because the restricting member 60 is located on the flanges 11, the restricting member 60 restricts the first bracket 10 rotating upwardly with respect to the first shaft 40. If the first bracket 10 needs rotate upwardly, the restricting member 60 can be omitted.

In succession, the second shaft portion 51 is inserted in the second pivot hole 24 of the second bracket 20. The protrusion 28 of the second bracket 20 is positioned in one positioning hole 55 of the end face 53 of the second shaft 50. The guiding piece 27 of the second bracket 20 is received in the recess 54 of the second shaft 50, and blocked by one barrier side 541 of the recess 54. A fastener 90 is screwed on the second shaft portion 51 to restrict the connection piece 23 of the second bracket 20 between the fastener 90 and the end face 53 of the second shaft 50. Therefore, the second bracket 20 can rotate about the second shaft portion 51.

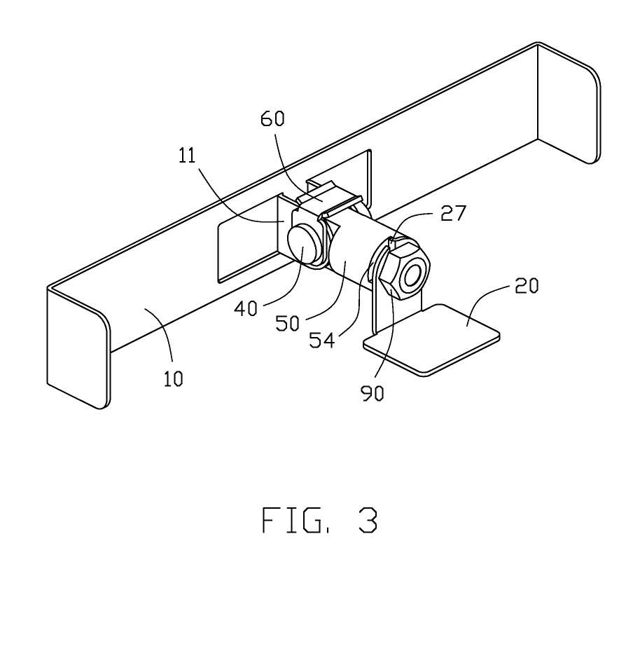

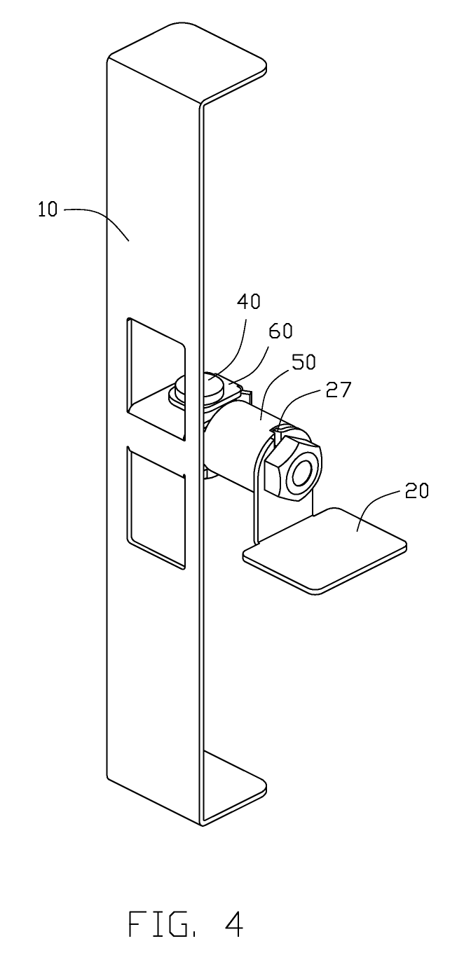

Referring to FIGS. 3 and 4, after the second bracket 20 rotates about the second shaft portion 51, the protrusion 28 escapes from the corresponding positioning hole 55, and is squeezed by the end face 53 to be resiliently deformed. Simultaneously, the guiding piece 27 slides in the recess 54. The second bracket 20 rotates until the guiding piece 27 is blocked by the other barrier side 541 of the recess 54. At this position, the protrusion 28 is in alignment with the other positioning hole 55 and secured in the other positioning hole 55.

Therefore, by using the above embodiment, the first bracket 10 can rotate about the first shaft portion 41 in a first dimension which is perpendicular to the first shaft portion 41 The second bracket 20 can rotate about the second shaft portion 51 in a second dimension which is perpendicular to the second shaft portion 51. In further, the restricting member 60 can prevent the first bracket 10 from rotating upwardly in the first dimension, but leave the first bracket 10 rotating downwardly in the first dimension.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A hinge, comprising:
a first shaft and a second shaft; the first shaft perpendicularly mounted to the second shaft; the second shaft comprising an end face, the end face defining a recess and two positioning holes, the recess defines two barrier sides;
a first bracket pivotally mounted to the first shaft and being capable of rotating about the first shaft; and
a second bracket pivotally mounted to the second shaft and capable of rotating about the second shaft; the second bracket comprising a guiding piece capable of sliding in the recess when the second bracket rotates about the second shaft; wherein the second bracket is rotatable about the second shaft between a first position and a second position; in the first position, the guiding piece abuts one barrier side, the protrusion is located in one positioning hole; in the second position, the guiding piece abuts the other barrier side, and the protrusion is located in the other positioning hole.

2. The hinge of claim 1, wherein the first shaft comprises a first shaft portion with a noncircular cross section; the second shaft defines a mounting hole therein; an axial direction of the mounting hole is perpendicular to an axial direction of the second shaft, and the mounting hole has a shape corresponding to the cross section of the first shaft portion, the first shaft portion is located in the mounting hole.

3. The hinge of claim 2, wherein the first bracket includes two flanges, each flange defines a first pivot hole; the second shaft is located between the two flanges with the mounting hole in alignment with the first pivot holes, the first shaft portion is located in the first pivot holes and the mounting hole, and the first bracket is capable of rotating about the first shaft portion.

4. The hinge of claim 3, further comprising a restricting member; wherein the restricting member is secured on the first shaft, the restricting member is located on one side of the flanges of the first bracket to restrict the rotation of the first bracket.

5. The hinge of claim 2, wherein the first shaft further comprises a head and a fixing portion; the head and the fixing portion are located on opposite sides of the second shaft when the first shaft portion is located in the mounting hole; a fastener is mounted on the fixing portion to secure the first shaft on the second shaft.

6. A hinge, comprising:
a first shaft and a second shaft; the first shaft perpendicularly mounted to the second shaft;
a first bracket pivotally mounted to the first shaft and capable of rotating about the first shaft; and
a second bracket pivotally mounted to the second shaft and capable of rotating about the second shaft.

7. The hinge of claim 6, wherein the first shaft comprises a first shaft portion with a noncircular cross section; the second shaft defines a mounting hole therein; an axial direction of the mounting hole is perpendicular to an axial direction of the second shaft, and the mounting hole has a shape to prevent full rotation of the first shaft portion, the first shaft portion is located in the mounting hole.

8. The hinge of claim 7, wherein the first bracket includes two flanges, each flange defines a first pivot hole; the second shaft is located between the two flanges with the mounting hole in alignment with the first pivot holes, the first shaft portion is located in the first pivot holes and the mounting hole, and the first bracket is capable of rotating about the first shaft portion.

9. The hinge of claim 8, wherein further comprising a restricting member, wherein the restricting member is secured on the first shaft, the restricting member is located on one side of the flanges of the first bracket to restrict the rotation of the first bracket.

10. The hinge of claim 7, wherein the first shaft further comprises a head and a fixing portion; the head and the fixing portion are located on opposite sides of the second shaft when the first shaft portion is located in the mounting hole; a fastener is mounted on the fixing portion to secure the first shaft on the second shaft.

11. The hinge of claim 6, wherein the second bracket defines a second pivot hole; the second shaft comprises an end face, a second shaft portion is formed on the end face, the second shaft is pivotally inserted in the second pivot hole.

12. The hinge of claim 11, wherein at least one positioning hole is defined in the end face; the second bracket comprises a protrusion capable of being positioned in the positioning hole.

13. The hinge of claim 12, wherein a recess is defined in the end face; the second bracket comprises a guiding piece capable of sliding in the recess.

14. The hinge of claim 13, wherein each of the two opposite side of the recess forms a barrier side; the guiding piece slides in the recess until the barrier side abuts the guiding piece.

15. The hinge of claim 14, wherein the at least one positioning hole comprises two positioning hole; when the guiding piece is resisted by one barrier side, the protrusion is positioned in one positioning hole, and when the guiding piece is resisted by the other barrier side, the protrusion is positioned in the other positioning hole.
